(19) United States
(12) Patent Application Publication
(10) Pub. No.: US 2017/0355496 A1
(43) Pub. Date: Dec. 14, 2017

(54) FILLABLE CLOSURE DEVICE WITH PUSH-BUTTON FOR RELEASING

(71) Applicant: BEVASWISS AG, Neuhausen am Rheinfall (CH)

(72) Inventor: Fritz SEELHOFER, Lindau (CH)

(73) Assignee: BEVASWISS AG, Neuhausen am Rheinfall (CH)

(21) Appl. No.: 15/536,592

(22) PCT Filed: Dec. 14, 2015
(86) PCT No.: PCT/EP2015/079573

§ 371 Date: Jun. 15, 2017

(30) Foreign Application Priority Data
Dec. 15, 2014 (CH) 01936/14

(51) Int. Cl. B65D 51/28; B32B 27/30; B32B 15/10; B32B 27/10; B32B 3/30; B32B 29/00; B32B 21/14; B32B 7/12; B32B 15/082; B32B 21/08

(52) U.S. Cl. CPC B65D 51/2821; B32B 15/082; B32B 27/306; B32B 15/10; B32B 21/08; B32B 3/30; B32B 29/002; B32B 21/14; B32B 7/12; B32B 27/10; B65D 51/2835; B32B 2307/582; B32B 2307/58; B32B 2435/02; B32B 2307/31; B32B 2255/26; B32B 2307/7246; B32B 2255/10; B32B 2307/7244; B65D 2217/02; B32B 2255/06; B32B 2307/732; B32B 2250/44; B32B 2307/71

(57) ABSTRACT

Closure device includes a closure cap, which can be screwed onto the threaded connection of a container, forming a fillable capsule that is open at the bottom, on which a seal directed downward is sealed. Upper side of the part of the closure cap which forms the capsule is designed to be deformable and can be pressed axially downward. A press element is molded on this cover of the closure cap at the bottom. By pressing the cover downward, the downward-directed seal of the capsule is broken open by the press element. Seal is made from a laminate comprising a carrier material with a thickness of at least 0.5 mm. Subsequently, a barrier film is sprayed or laminated on the carrier material. The crimping forms a circumferential edge, by means of which the seal can be sealed to the capsule edge, on the inner side of the carrier material, with respect to the capsule, and resting on same. The carrier material has pre-notches in the form of cuts, which approximately cut through the carrier material yet leave the attached films intact.

The present invention refers to a fillable closure device, which may be released by means of a push-button, so that either a separately filled capsule arranged inside the closure device is thereby opened and is emptied into the container provided with the closure device, or the closure device itself forms such a capsule, which is then opened.

Many beverages are nowadays already produced by mixing a concentrate with water. Instead of distributing the finished mix, it would be much more efficient if the bottle filler would fill only water on site, and the concentrate be added to the water in the bottle by the consumer opening the bottle for the first time, and then mixing it with the same. The adding of all sensible active substances and light sensitive vitamins may be provided by such a closure device.

A known solution for metered addition of a separate liquid is comprised of a plastic dosing closure and corresponding container neck for a container, as disclosed in WO 2012/175,317 A1. This solution provides a fillable closure device with a push-button for release, which operates with a separately filled capsule. The closure device is comprised of a closure cap, which may be screwed on the threaded connector of a container, in which this separately filled capsule in the closed state may be inserted from below, with a seal film of capsule downwardly directed. The upper side of the inserted capsule is deformable and may be axially pushed downward, so that the downwardly directed sealing film of capsule is broken or may be exploded. According to this document, this is achieved by an axially and downwardly protruding profile, which is formed on the underside of the closure cap, which is fitted into a recess in the deformable upper side of the inserted capsule, which is fitted to the cross section of said profile. By pressing this profile downwards into the recess, the outer lower corners of the profile are pressed on the sealing film of capsule. The sealing film is provided with weakening lines, so that these corners impact the bisecting line of circle segments formed by the weakening lines, and after bursting the weakening lines, these segments may be pivoted by the corners of profile in the downward direction and are then held in the downwards tilted position. In reality it happens that this solution is fundamentally working, although not without exceptions, i.e. not in 100% of cases. This solution is therefore not sufficiently suitable for practical implementation, in which hundreds of thousands of closure devices have to be delivered and each of those has to work perfectly.

The object of the present invention is therefore to provide a fillable closure device, whose filling falls into the container provided with the same closure device, by operating a push-button, either by emptying a separately filled capsule arranged inside the closure device by releasing into the container, or by the fact that the closure device itself forms such a capsule, which is emptied by releasing the push-button. This fillable closure device has to be easier to manufacture and install, has to be comprised of a minimum amount of components, and has to be operated by a single operation—a single action —, so that its filling may be emptied with absolute certainty and reliability into the container provided with such a closure device. The closure device has to ensure, in particular, that the seal, once burst open, cannot get halfway due to elastic forces. Moreover, in a particular embodiment, the filling of capsule in the closure device has to be protected against penetration of oxygen, UV radiation and water vapor coming from the environment.

This object is achieved by a fillable closure device with push-button for releasing the emptying process, comprising a closure cap which can be screwed onto the threaded connector of a container, said closure cap forming a fillable capsule, that is open at the bottom, or in which a separate fillable capsule may be inserted, with a seal of the capsule which is directed downward, wherein the upper side of the capsule is designed to be deformable and can be pressed axially downward, so that the seal of capsule which is directed downward may be broken or burst open by this action, in that on the underside of the closure cap an axially downward protruding profile is formed, for pressing the seal of capsule, characterized in that the press element in the closure cap has a V-shaped cross section perpendicular to the rotational axis of the closure cap, so that two walls are formed as legs, which are connected, along their length, integrally with the bottom of the capsule, and that the downwards directed free edges of this press element having a V-shaped cross section rise to a point, where both walls meet, so that by down-pressing of the press element, the underlying film may be initially perforated or broken open by the point and then be folded away by the edges of walls.

In this way, the bursting takes initially place in a controlled manner, and the seal, which is burst open, is held open securely. The capsule is emptied by pressing down the push-button due to a reduction of its volume, and moreover, the downward directed segments of seal are reliably rotated downwards and the capsule is therefore held open, so that the content of the capsule may drain reliably and completely in the container provided with the closure device. Moreover, due to the laminated structure of seal, the tightness against penetration of oxygen, water vapor or UV radiation is guaranteed.

In figures, various variants of this fillable closure device with push-button for release are shown in different views. The closure device and its function are described in detail based on these figures.

In particular:

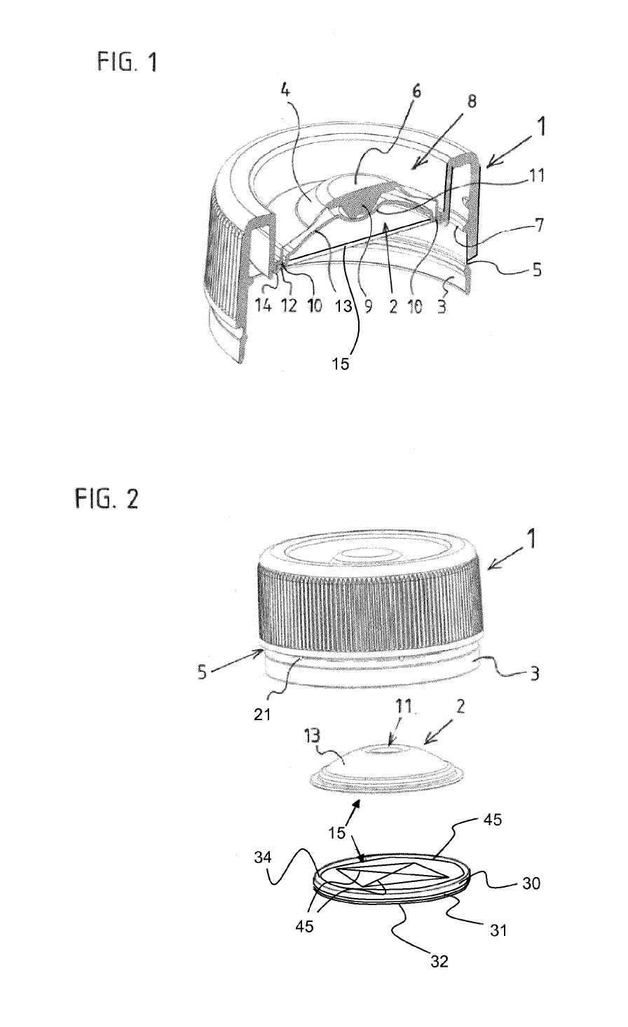

FIG. 1 shows a first variant with direct activation of capsule emptying in a perspective cross section;

FIG. 2 shows the closure device with corresponding separately filled capsule and separately drawn seal;

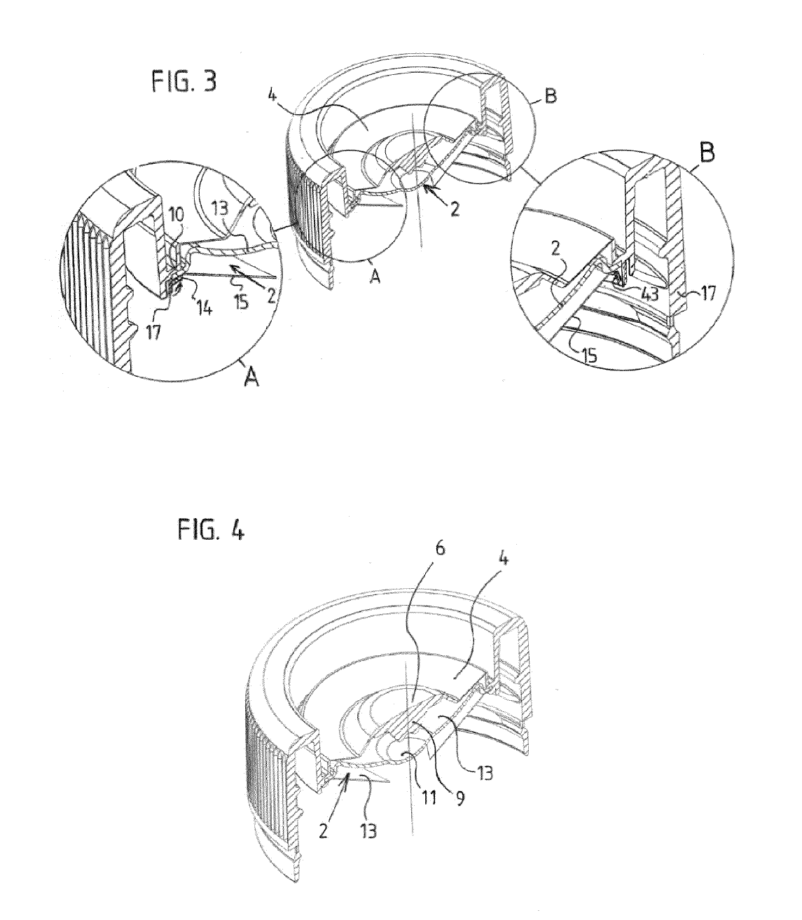

FIG. 3 shows the closure device in a perspective cross section, and beside it the crimpable edge of the capsule, which may be inserted from below, for fixing the same, as detailed solution A and as an alternative a barb for holding capsule as detailed solution B;

FIG. 4 shows said closure device after pushing down of push-button, with burst seal and emptied capsule;

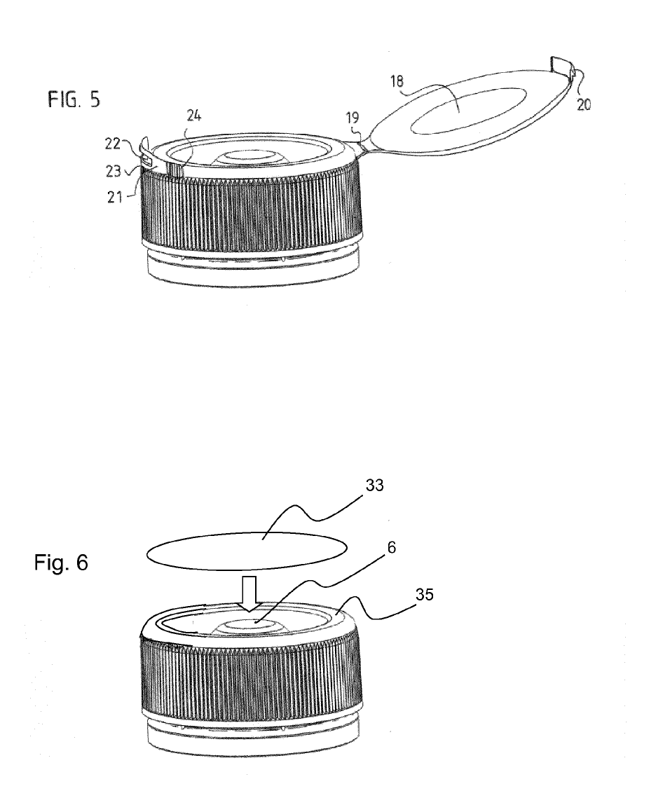

FIG. 5 shows a first solution of the tamper-evident guarantee on closure device;

FIG. 6 shows a second solution of the tamper-evident guarantee with simultaneous oxygen, UV and water vapor barrier on the outer side of capsule;

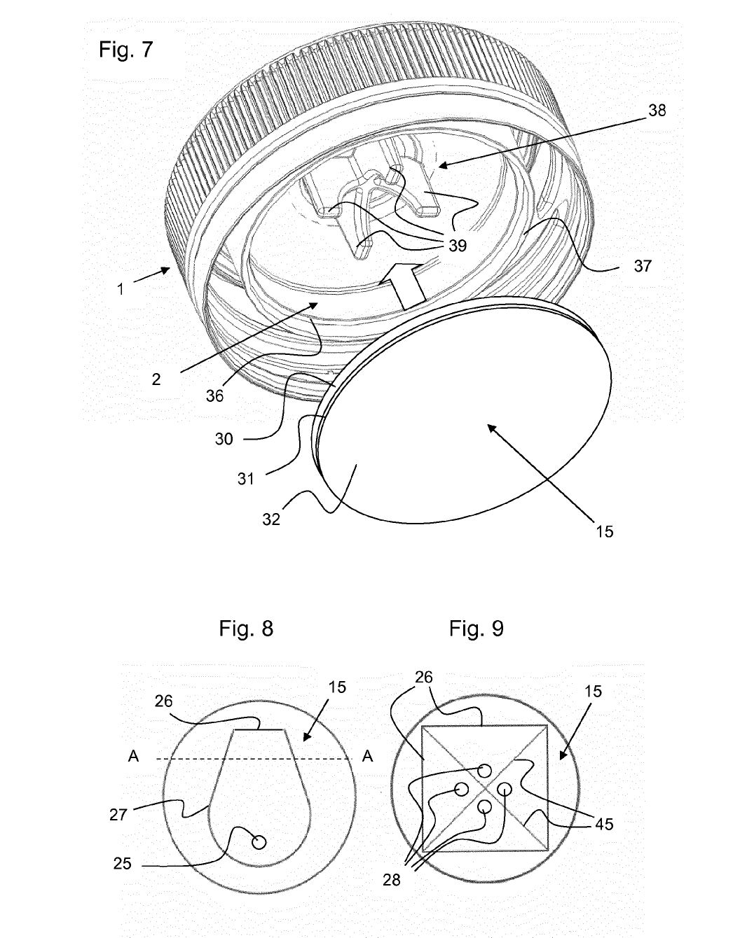

FIG. 7 shows a second variant of the closure device with an inferiorly open capsule which is provided by the closure cap itself, which capsule may be filled separately in a toppled position of closure, as well as corresponding seal;

FIG. 8 shows a seal with a horse-shoe-shaped pre-notch of carrier material;

FIG. 9 shows a seal with a squared pre-notch and pre-notches diagonally positioned inside the square;

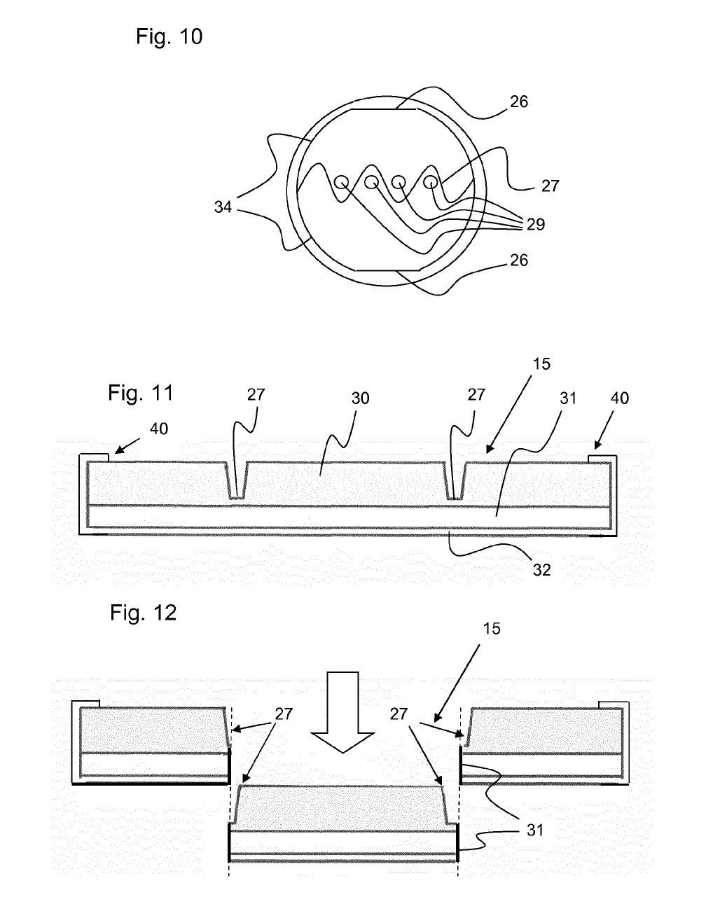

FIG. 10 shows a seal with two straight hinge lines and a corrugated fracture line and two semicircular fracture lines;

FIG. 11 shows seal of FIG. 8 in a cross section along line A-A in FIG. 8;

FIG. 12 shows seal of FIG. 11 after pressing and breaking of horse-shoe-shaped tab;

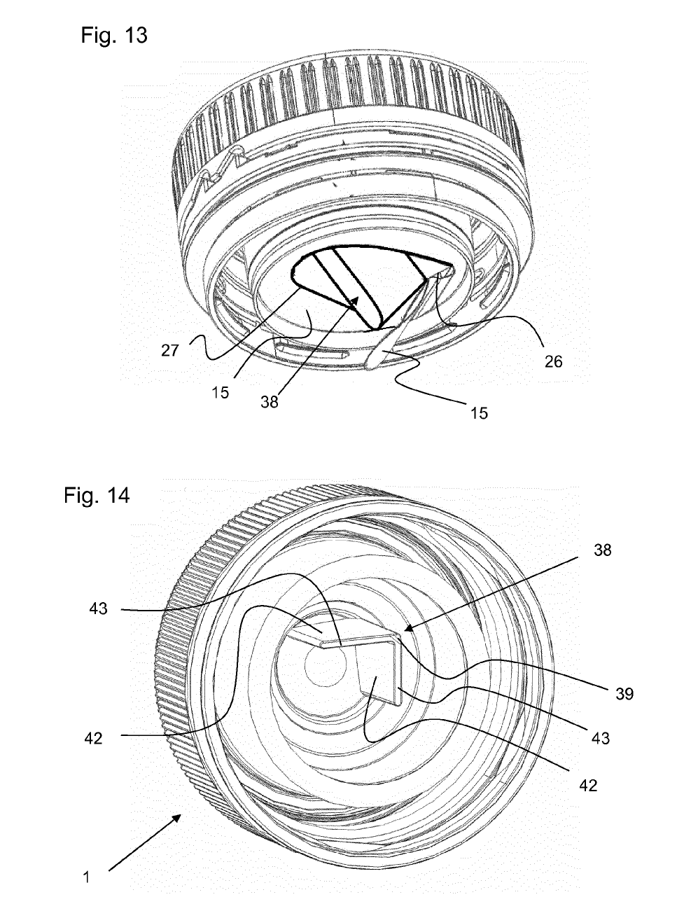

FIG. 13 shows the closure cap with down-pressed push-button in an oblique view from below, after breaking open and pivoting of breakable part of seal;

FIG. 14 shows closure cap in an oblique view from below, with a press element having a V-shaped cross section, which ends downwards in a point at closure cap;

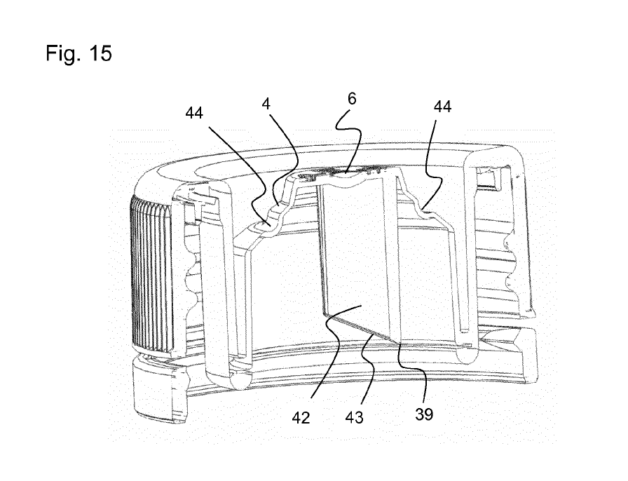

FIG. 15 shows closure cap of FIG. 14 in a diametric section.

FIG. 1 shows a first variant of this closure device, which allows the emptying of the separately filled and inserted capsule 2 with a single direct actuation. The closure device forms a closure cap 1 with an inner thread 7, so that it can be screwed on a threaded connector of a container. The closure cap 1 is provided on its lower edge with a circumferential band 3, which is connected to the closure cap 1 by means of a thinned portion 5. This band 3 provides a tamper-evident guarantee and remains on the bottle connector when unscrewing the closure cap 1, when the bottle is opened for the first time, since the thinned portion 5 is broken. The closure cap 1 has on its upper side a recess 8, i.e. a depression in the lid surface. This lid surface of this example is provided as a gable-shaped push-button 4, which is axially deformable, and whose flattened point forms a circular press surface 6. The press surface 6 is formed on its underside in a boss 9 as a press element, and the wall of push-button 4 is relatively thin, so that the push-button 4 may be pressed downwards by the convex form as seen from above by pressing on the press surface 6 in axial direction, deforming the push-button wall. The push-button 4 may so be pressed downwards in a form which looks concave as seen from outside. On the underside of push-button 4, it forms with its outer edge a circumferential shoulder 10 which protrudes downwards. On this shoulder 10 a circular capsule 2 may be applied from below, wherein the capsule rests fittingly with its outer edge on this shoulder and is held on the same by a flanging 14. This capsule 2 is composed in turn of a dome-shaped upper part, which terminates at the outer edge with a projection 12 with an upper and lower flat side. At the center of the upper part of capsule 2 a recess 11 is formed, in which the boss 9 on push-button 4 is inserted. For filling, this dome-shaped upper part of capsule 2, which still forms a separate part, is brought into a toppled arrangement, so that it forms a cup. This cup is filled and then the capsule 2 is sealed or welded by a circular disc-shaped seal 15 of laminate, which fits on the capsule edge. Then capsule 2 is hermetically closed, and in this way an aseptic filling and sealing is ensured. The dome-shaped upper part of capsule 2 contains an aluminum foil and also the seal 15 contains such a foil, in order for the capsule 2 to be sealed against oxygen and light. In this way it is possible to perform a filling also with most sensitive, light sensitive substances.

FIG. 2 shows the closure device with the corresponding separately filled capsule 2 with its domed upper part 13 before use. It is inserted from below, its convex upper side 13 first, into closure device 1. Capsule 2 has a flat underside and is closed by separately drawn seal 15. This seal 15 is in particular made of a laminate, since it has to provide different functions, namely:

1. allow hermetical closure of capsule 2 by sealing or welding with capsule edge

2. ensure oxygen tightness,

3. ensure water vapor tightness,

4. ensure UV shielding of capsule content

5. ensure breaking by actuation of push-button

6. ensure open position after breaking open.

To this end, said seal 15 is composed of a laminate, with a carrier material 30 of at least 0.2 mm thickness. As said carrier material 30, a circular cardboard disc may be suitable, for example. Also, a plastic disc, a wood cut disc or a circular disc made of pressed organic material may be suitable. Relative to capsule 2, in an outwards direction, it follows a barrier film 31 glued onto carrier material 30, which is made of aluminum or EVOH-film, for example. These materials act as a barrier against oxygen, UV and water vapor. Other materials may also be used, provided that they have a barrier function against oxygen, water vapor and UV radiation. On this barrier film 31, composed of aluminum or EVOH film, a sealing layer 32 of paint or PE-laminate layer is sprayed or laminated. This sprayed paint or laminate layer 32 is drawn around the outer edge of seal 15, so that it initially crimps the outer edge of barrier film 31, for instance the aluminum or EVOH-film, and the edge of carrier material 30, forming on inner side of carrier material 30, relative to capsule a circular edge 34 resting on the same, by which the seal 15 may be sealed with the capsule edge. The total thickness of seal is in this case equal to about 0.3 mm. However, it is evident that also thicker seals may be used, in particular when the diameter of the container connector and therefore the closure capsule is larger and provides a larger capsule diameter. The carrier material 30 is provided with special pre-notches, which may be formed by a cutting plotter. This cutting plotter may perform, using a very sharp knife, very precise and thin cuts. In the example shown, a square was cut out, wherein cuts terminate shortly before the lower end of carrier material thickness, therefore leaving a very thin material bridge. The corners of square are connected to diagonal cuts 45, which also extend up to the lower end of carrier material 30, without reaching the underlying barrier film 31, i.e. the aluminum or EVOH-film, so that the latter remains intact and may unfold its function as an oxygen, water vapor and UV barrier. These cuts 45 form weakening lines, in order for the seal 15, as shown in the following, to be broken precisely along these weakening lines. Cuts or weakening lines 45 may also have different shapes, other than a cross and square, as shown in the following. The seal 15 is applied over the projection 12 (FIG. 1) when upper part 13 is toppled, and is sealed or welded with same. The convex upper side 13 has a central recess 11, in which the boss 9 on closure cap 1 is set to protrude. On lower edge of closure lid 1 the guarantee band 3 is shown, which is formed over a continuous thinned portion 5 or some material bridges 21. On later unscrewing the closure cap 1, the thinned portion 5 is sheared, or material bridges 21, which provide predetermined breaking points, break and release the closure cap 1 for unscrewing.

Detail A of FIG. 3 shows a first solution for holding capsule 2 in closure cap 1. In order to attach capsule 2 on the downwards protruding shoulder 10 on underside of dome 4, shoulder 10 is provided, on its outer edge, in this solution, with a perpendicular protruding wall attachment 17, which axially extends to closure. After inserting capsule 2, the wall attachment 17 is folded in a warm state inwardly towards the center of the closure device, as shown by a small curved arrow, and is pressed on seal 15 and cooled. Thenceforth, capsule 2 is securely fixed in closure device 1 by crimping 14. As an alternative—as shown by detail solution B—a plurality of formed barbs 43 may be distributed along the circumference of wall attachment 17. Capsule 2 may then be snapped with its edge into these barbs 43, whereby it is securely held in this position.

In FIG. 4 closure device is shown in a perspective cross section after pressing down of press surface 6. Due to pressing down of press surface 6 and therefore of push-button 4 in downward axial direction, boss 9 presses against the underlying recess 11 in upper side 13 of inserted capsule 2. Content of capsule 2 therefore presses from the inside on its underside, i.e. inwardly on seal 15. If pressure is sufficiently increased, seal 15 breaks or tears due to elongation stress along weakening lines 45 (FIG. 2) and capsule content completely falls downwards from the same.

FIG. 5 shows a first solution for providing a tamper-evident guarantee on said closure device, as shown in FIGS. 1 to 4. In fact, when closure cap 1 is provided as shown in previous figures, anyone can press the freely accessible press surface 6 downwards, emptying capsule 2 into the bottle content. This pressing on press surface 6 may be performed with malicious intent: simply as a practical joke, someone could easily press down the press surface 6 in a row of bottles on a shelf. The inhibition for such a prank is relatively low. In order to avoid this, the closure cap 1 shown has a lid 18 which is formed, in a hinged manner, on its edge. The lid 18 is provided on its outer edge, i.e. on side of lid 18 opposed with respect to hinge 19, with a pawl 20 which acts as a snap element. If the lid 18 is tilted and rotated downwards on the closure cap 1, pawl 20 hooks into a window 22 on a strip 21 which is formed on the same. The lid 18 may then be rotated into an open position, releasing access to push-button 4 and its press surface 6 only when the strip 21 has been previously torn away from closure cap 1. To this end, the strip 21 is formed, via a thinned portion 23, on the upper outer edge of closure cap 1. The strip 21 may be grasped at the grip tab 24 and torn away along the circumference of closure cap 1, breaking the thinned portion 23. In order to prevent careless disposal of such strip 21, thinned portion 23 may be provided on a partial length of strip 21, so that strip, after partial tearing, is securely held on closure cap 1, nonetheless releasing the pawl 20, so that lid 18 may be rotated in the open position. The entire closure solution is essentially composed of three parts, i.e. the lid cap 1 with its integrally formed lid 18, if necessary, for tamper-evident guarantee, then the separately fillable capsule 2, which in turn is composed of two parts, i.e. the domed upper side 13 as a cup-shaped injection-molded part and seal 15 for the closing of capsule—hence, only three parts in total!

FIG. 6 shows a second variant of a tamper-evident guarantee, wherein on the upper side of closure cap 1 an aluminum or EVOH-film 33 is glued, in particular along its edge region 35, so that it rests on the press surface 6. At the time of first use, i.e. when pressing down the push-button, this film 33 is destroyed, therefore acting as a tamper-evident guarantee. At the same time, however, and this is very important, it also acts as a barrier against oxygen, water vapor and UV radiation on the upper side of closure device, so that the inner capsule and its content are also protected from above.

A particularly elegant and efficient, i.e. cost efficient and nonetheless technically exceptionally effective embodiment of this fillable closure device, which may be released by push-button, is shown in FIG. 7. In this case, closure cap 1 itself forms the capsule 2, in that on the underside of closure cap lid a cylindrical wall 36 is formed, on whose lower edge 37 the seal 15 is sealed. At the center of the underside of closure cap lid a press element 38 is positioned, which has, in this case, a stool-like shape with four downwards directed legs 39. These legs press with their lower ends on targeted points on seal 15, which has been previously weakened by precisely arranged pre-notches. FIGS. 11 and 12 show the function of pre-notches. Seal 15 is composed of the carrier material 30, the barrier film 31 made of a film of aluminum or EVOH and the sealing film or PE-laminate layer 32, which upwardly crimps around the edge of seal 15 and rests from above on the edge region of seal 15. This seal 15 may then be directly sealed, after filling of capsule 2, in a toppled position of closure cap 1, on edge 37 of cylindrical wall 36. If the closure cap 1 is still adhered on its upper side by the aluminum or EVOH-film, then the content of capsule is hermetically enclosed and protected against penetration of oxygen, water vapor and UV radiation. A penetration of these substances or UV radiation in a radial direction can be ruled out due to thickness of material of threaded cap, container connector and cylindrical wall of capsule. At the same time, as already shown, a tamper-evident guarantee is therefore obtained. This embodiment of the closure device is also very interesting from an economic perspective. It does not require a separately manufactured capsule, which lowers costs. Moreover, tightness of capsule is exceptional. The entire closure device with capsule function is only composed of two components, as well as an optional film on lid of closure device, if upper sealing against oxygen, water vapor and UV radiation is also required.

FIG. 8 shows an example of a pre-notch, i.e. a horse-shoe-shaped cut 27. The ends of this cut 27 are connected by means of a straight cut 26. The press element 38 has therefore to act in the anterior region of the horse-shoe comprised by the cut 27, approximately on point 25 on this surface. If a pressure is applied thereon, the thickness of carrier material 30 is influenced by geometry so that high lever forces are generated, which give rise to high stresses underneath the cut, in a transversal direction with respect to cut, so that the underlying film 31 is torn open exactly in that position, and is then cut along the horse-shoe-shaped cut line 27, while the horse-shoe-shaped tab, which is enclosed by this line is rotated downwards around the straight cut line 26. The unbroken film along line 26 then functions as a hinge.

FIG. 9 shows an example of a pre-notch with straight cuts 26, 45. A square is cut out with these straight cuts 26 or the carrier material 30 is almost cut through. Then the diagonals 45 are also almost cut through. Points 28, at which the press element 38 has to be applied, which have to be subject to pressure, lie near the crossing point of diagonals 45. Here also pressure on drawn points 28 generate high tension forces underneath cut lines 45 and transversal to same, due to lever action of thick carrier material 30, and underlying films 31, 32 are broken along these diagonal cuts. The cut open triangular segments in seal 15 are rotated downwards about the straight lines 26, providing a reliable emptying of capsule.

FIG. 10 shows a further example of a pre-notch with straight cuts 26 and curved cuts 27. Pressure points 29 for press element 38 are positioned along a line. By pressing, the seal 15 initially breaks along the serpentine line 27 and thence along the semicircular cut lines 34, while the unbroken film along the straight cut lines 26 functions as a hinge. The cut out parts on both sides of serpentine line 27 are folded downwards about the cut lines 26 and ensure a complete emptying of capsule.

FIG. 11 shows a cross section through seal 15, along dashed line A-A of FIG. 8. Seal 15 is composed of a laminate. On the uppermost level, the laminate, which is directed towards the capsule inside, is comprised of a cardboard disc, a plastics disc or a wood veneer disc, for example. On this laminate a barrier film 31, an aluminum film or an EVOH-film is glued, for example, on the underside. At the lowest level, the seal is provided with a sealing paint 32, or with a PE-laminate layer. This paint or PE-laminate layer 32 is upwardly flanges about the edge and comprises the seal 16 about its edge and rest on the upper side of its edge region 40.

FIG. 12 shows how the seal 15 is perforated, when the horse-shoe-shaped tab is subject, in its anterior region, to a pressure by the press element 38. The thin portions of barrier film 31, which are weakened by the pre-notches 27, i.e. the aluminum or EVOH-film, for example, are perforated and the tab is rotated downwards about the hinge line 26.

FIG. 13 shows this rotation of the horse-shoe-shaped tab about the hinge 26 formed along the straight cut line 26, while the tab has been separated along the cut line 27 from seal 15. The press element 38 rotates the tab downwards and holds it then in this tilted position, so that it cannot rotate back, so that the capsule may be completely emptied.

FIG. 14 shows a further variant of a closure cap with special press element 38. This element has a V-shaped cross section. This means that two legs like walls 42 are formed, which are connected along their length fixedly and integrally with the bottom of capsule 2. Free edges 43 on closure cap 1, which are directed downwards, of this V-shaped press element 38 rise towards a point 39, where both walls 42 meet each other. In this way a very stable puncturing and press point 39 is formed. This press element 38 is particularly stable due to its arrangement. If it is pressed by pushing from above on the film positioned under the press element 38, the press element point 39 initially punctures or breaks the film, whether or not provided with weakening lines, and then the upper edges 43 of walls 42 act on the opened film and fold it downwards, for ensuring the emptying of capsule.

FIG. 15 shows a diametric section through this closure cap of FIG. 14. It may be seen that the push-button 4 has a circumferential inwardly curved groove 44 in its wall, which facilitates and assists collapsing of push-button 4 in case of pressing on press surface 6. Obviously, the push-button wall may also be provided with a plurality of such grooves 44, even outwardly curved ones, or the wall may also form a serpentine line or a bellows in the radial direction.

### LIST OF REFERENCES

1 closure cap
2 capsule
3 circumferential band inferiorly at 1 (guarantee band)
4 push-button on closure cap
5 thinned portion
6 press surface on push-button
7 inner thread of closure cap
8 recess on upper side of closure cap
9 boss inferiorly on press surface
10 shoulder on push-button
11 recess at zenith of capsule 2
12 planar radial projection on separate capsule
13 domed upper side of separate capsule
14 flanging on insertable capsule
15 seal for capsule
16 material bridges
17 hinge
18 hinge
19 hinge
20 pawl
21 strip
22 window
23 thinned portion
24 grip tab
25 pressure portion
26 straight cut
27 curved cut
28 points in square
29 pressure points at serpentine line
30 carrier material seal 15
31 barrier film, aluminum or EVOH-film, for example
32 sealing paint or PE laminate layer
33 EVOH-film upper side on lid of closure cap
34 semicircular cuts (FIG. 10)
35 edge upper side on closure cap
36 cylinder wall inferiorly in the closure cap
37 edge of cylinder wall
38 press element
39 leg on stool-like press element
40 edge region of seal 15
41 material bridges
42 walls of V-shaped press element
43 free edges of V-shaped press element
44 curved groove in push-button wall

1.-10. (canceled)

11. A fillable closure device with push-button for releasing the emptying process comprising:
a closure cap which can be screwed onto the threaded connector of a container, said closure cap forming a fillable capsule, that is open at the bottom, or in which a separate fillable capsule may be inserted, with a seal of the capsule which is directed downward,
an upper side of the capsule is designed to be deformable and can be pressed axially downward, so that the seal of capsule which is directed downward may be broken or burst open by this action, in that on the underside of the closure cap an axially downward protruding press element is formed, for pressing the seal of the capsule,
wherein the press element in the closure cap has a V-shaped cross section perpendicular to the rotational axis of the closure cap, so that two walls are formed as legs, which are connected, along their length, integrally with the bottom of the capsule, and that the downwards directed free edges of this press element having a V-shaped cross section terminate into a point, where both walls meet, or alternatively that the press element is formed on the closure cap in order to rotate about an axis perpendicular to the rotational axis and in the tilted condition, forms a point protruding downwards, so that in both variants with down-pressing of the press element, the underlying film may be initially perforated or broken open by the point and then folded by the press element,
wherein the seal is made of a laminate comprising:
a carrier material with a thickness of at least 0.2 mm, having a barrier film as an oxygen, water vapor and UV-radiation barrier externally adjacent to the capsule and
a sealing layer, on the barrier film, formed by paint or a PE laminate layer is sprayed or laminated, which crimps the seal at its outer edge, around the edge of the barrier film and the edge of the carrier material and on which, on the inner side of carrier material, with respect to the capsule, it forms a circumferential edge, by means of which it may be sealed to the capsule edge, and that the carrier material has pre-notches in the form of cuts, which approximately cut through the carrier material, yet leave the adjacent films intact.

12. The fillable closure device with push-button for releasing the emptying process of claim 11, wherein the wall of the push-button has at least one circumferential groove, which is inwardly or outwardly curved, for supporting and facilitating the collapsing of the push-button by pushing on the press surface.

13. The fillable closure device with push-button for releasing the emptying process of claim 11, wherein the wall of the push-button forms a serpentine line in a radial direction through a plurality of grooves or the wall is in the form of a bellows.

14. The fillable closure device with push-button for releasing the emptying process of claim 11, wherein the capsule is formed by the closure cap itself, in that it forms a cylindrical wall on the underside of the lid of the closure cap, and the filled capsule in the toppled position may be closed by the seal, which may be sealed on the lower edge of the cylindrical wall.

15. The fillable closure device with push-button for releasing the emptying process of claim 11, wherein the capsule is protected, on its side formed by the lid of the closure cap against penetration of oxygen, water vapor and UV radiation, in that on the outer side of the lid of closure cap an aluminum or EVOH film is glued along the edge area of the lid, so that this film rests on the press surface of the press element and simultaneously forms a tamper-evident guarantee.

16. The fillable closure device with push-button for releasing the emptying process of claim 11, wherein the capsule is a separately manufactured and filled capsule, which may be inserted from below into the closure cap, and which, in the toppled position, deforms its upper side so that the press element on the underside of lid of closure cap fits in same and is oriented towards selected pressure points on the seal.

17. The fillable closure device with push-button for releasing the emptying process of claim 11, wherein the seal is made of a laminate composed of a carrier material in the form of a cardboard disc, plastic disc, it is glued on the barrier film and in that on the barrier film a sealing paint or a PE-laminate layer is sprayed or laminated, wherein this sealing paint or the PE-laminate layer crimps the outer edge of the seal and rests on the upper side on the edge region of seal and may thereby be sealed with the capsule.

18. The fillable closure device with push-button for releasing the emptying process of claim 11, wherein the carrier material of seal has pre-notches, which form a square and diagonals inside this square, so that four triangles are formed, which may be pivoted away along the square sides.

19. The fillable closure device with push-button for releasing the emptying process of claim 11, wherein the carrier material of seal has pre-notches, which are composed of a horse-shoe-shaped cut as well as a straight cut connecting both ends of the same, wherein the material along this cut is configured to act as a hinge in case of rotating away the broken out horse-shoe-shaped tab.

20. The fillable closure device with push-button for releasing the emptying process of claim 11, wherein the carrier material of seal has pre-notches, which are composed of an approximately whole circular cut along the edge of the seal, wherein this cut forms a respective straight secant cut on both sides of the circle, and in a parallel direction with respect to both straight secant cuts in the center of the sealing film a serpentine line extending along the diametrical line is cut out, so that both halves on both sides of the serpentine line may be rotated away about the secant cuts.
